(19) United States
(12) Patent Application Publication
(10) Pub. No.: US 2022/0294374 A1
(43) Pub. Date: Sep. 15, 2022

(54) SYSTEM AND METHOD FOR CONTROLLING A 3-PHASE TRANSFORMER DEVICE

(71) Applicant: EM-Energy Solutions AS, Trondheim (NO)

(72) Inventor: Vidar Grøset, Trondheim (NO)

(73) Assignee: EM-Energy Solutions AS, Trondheim (NO)

(21) Appl. No.: 17/634,953

(22) PCT Filed: Aug. 15, 2019
(86) PCT No.: PCT/EP2019/071957

§ 371 Date: Feb. 11, 2022

(51) Int. Cl. H02P 13/06; H01F 29/02; H02J 3/26

(52) U.S. Cl. CPC H02P 13/06; H01F 29/02; H02J 3/26

(57) ABSTRACT

The embodiments herein relate to a system (100) for controlling a 3-phase transformer device (101, T1, T2, T3). The system (100) comprises the 3-phase transformer device (101, T1, T2, T3) which comprises a primary side and an adjustable secondary side. The system (100) comprises at least one voltage sensor (S1, S2, S3) adapted to sense voltage at the primary side. The system (100) comprises a current sensor (S4) adapted to sense current through the adjustable secondary side, and a resistor (R1) connected in series with the current sensor (S4) at the adjustable secondary side. The system comprises a controller (103) adapted to obtain sensor data indicating the sensed voltage and the sensed current, and to control a parameter associated with the adjustable secondary side of the 3-phase transformer device (101, T1, T2, T3) based on the obtained sensor data.

### TECHNICAL FIELD

Embodiments herein relate generally to a system and a method performed by the system. More particularly the embodiments herein relate to controlling a parameter associated with an adjustable secondary side of a 3-phase transformer device.

### BACKGROUND

Today's use of power electronics and the increased utilization of electronic devices in general have led to increasing requirements on the quality of the power grid. The industry has large costs each year related to unstable power grid and harmonic disturbances. An unstable power grid reduces the life time of electrical devices, reduces efficiency and increase energy consumption in electric devices. This leads to troubleshooting and change of electric devices, and to reduced production due to down time. Due to this, it is a need for a system which, at any time, can provide information related to the state of the power grid and also being able to react to voltage instabilities and harmonic disturbances. There is also a need for a system that can protect or at least reduce transient events and to provide information and trigger necessary alarms.

Today's equipment which protects electronics against transient voltages, voltage pulses and over voltages such as electric arc and lightning are based on semiconductor components such as Metal Oxide Varistor (MOV), Selenium cells and avalanche diodes or thermal protection which burns excess energy or directs energy to ground in order to protect the circuit where they are installed.

Most of the current handling of harmonic noise is based on active and passive filters. Filters mostly cover a small part of the frequency area and needs to be adapted to each specific case.

Semiconductor components such as MOV, selenium cells and avalanche diodes consumes excess energy in a circuit when over voltage, transient voltage or a voltage pulse occurs. A problem with this is heating in components and deterioration of components at repeatedly occurring voltage pulses over time. These components break which results in down time of the equipment. Presently existing Surge Protection Devices (SPD) are controlling the current at the time of an event. Ratings of 50 kA up to 300 kA are seen for incredibly short periods of time, but such massive energy has its' effect on electronics it is meant to protect, as well as the SPD itself. The existing technologies utilize MOVs that degrade each time they operate. To achieve the higher levels as described earlier, they place multiple MOVs in parallel. High voltages cause early failure of electrical equipment. Smaller surges, on a regular basis, steadily erode electrical components and pose a significant threat to electrical systems. A failure or malfunction in electrical equipment leads to high financial and operational losses, thereby, affecting the profitability of an organization. MOVs do not limit the voltage spike to its rating but allows the voltage to surge up to five times its operational voltage allowing this spike to affect the critical loads it is meant to protect.

Thermal protection breaks the circuit and leads the energy to ground when over voltage occurs. A problem with this is that thermal protection is “slow”, and voltage and current transients caused by for example lightning strikes, switching of reactive loads and operation of power electronics can propagate in the electrical system before the thermal protection reacts.

Therefore, there is a need to at least mitigate or solve this issue.

### SUMMARY

An objective of embodiments herein is therefore to obviate at least one of the above disadvantages and to provide improved control of the 3-phase transformer device.

According to a first aspect, the object is achieved by a system comprising a 3-phase transformer device having a primary side and an adjustable secondary side. The system comprises at least one voltage sensor adapted to sense voltage at the primary side of the 3-phase transformer device with reference to ground. The system comprises a current sensor adapted to sense current through the adjustable secondary side of the 3-phase transformer device. The system comprises a resistor connected in series with the current sensor at the adjustable secondary side of the 3-phase transformer device. The system comprises a controller adapted to obtain sensor data indicating the sensed voltage from the at least one voltage sensor and the sensed current from the current sensor, and to control a parameter associated with the adjustable secondary side of the 3-phase transformer device based on the obtained sensor data.

According to a second aspect, the object is achieved by a method performed by a system for controlling an adjustable secondary side of a 3-phase transformer device. The system receives electrical power from a power grid. The system senses voltage at a primary side of the 3-phase transformer device with reference to ground and with at least one voltage sensor. The system senses current trough the adjustable secondary side of the 3-phase transformer device with a current sensor. A resistor is connected in series with the current sensor at the adjustable secondary side of the 3-phase transformer device. The system obtains, with a controller, sensor data indicating the sensed voltage from the at least one voltage sensor and the sensed current from the current sensor. The system controls, with the controller, a parameter associated with the adjustable secondary side of the 3-phase transformer device based on the obtained sensor data.

Since the controller is adapted to control a parameter associated with the secondary side of the 3-phase transformer device using the sensor data from the system's sensors, it improves the control of the 3-phase transformer. The sensor data used in the control is continuously obtained such that the controller is always based on current sensor data. Due to the use of continuously obtained sensor data, the controller takes into account any change in the sensor data that may occur. Using other words, the control of the secondary side of the 3-phase transformer device is a dynamic control.

Embodiments herein afford many advantages, of which a non-exhaustive list of examples follows:

An advantage of the embodiments herein is that they provide improved control of a 3-phase transformer device.

Another advantage of the embodiments herein is that they reduce cost, increases lifetime, increases efficiency, reduces downtime because of prolonged life of electrical equipment and reacts on any voltage imbalance and equalizes the voltage between all phases with the speed of the current. Single phased variable transformers are dynamically controlled, using sensor data from the system sensors.

A further advantage of the embodiments herein is that they enables the operator of the system to obtain information about the system's status at any time and to inform the operator about errors, errors that are about to occur etc.

Another advantage of the embodiments herein is that they enable increased personal safety, they reduce electrical waste and materials, and they also enable reduced CO₂ emissions.

An advantage of the embodiments herein is that the reduce energy consumption.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail by way of example only in the following detailed description by reference to the appended drawings illustrating the embodiments and in which:

FIG. 1 is a schematic block diagram illustrating a system.

FIG. 2 is a schematic drawing illustrating an automatic waveform restorer.

FIG. 3 is a schematic drawing illustrating an automatic voltage equalizer.

FIG. 4 is a graph illustrating an example of power loss.

FIG. 5 is a graph illustrating an example of power loss.

FIG. 6 is a graph illustrating an example of current.

FIG. 7 is a flow chart illustrating a method.

The drawings are not necessarily to scale and the dimensions of certain features may have been exaggerated for the sake of clarity. Emphasis is instead placed upon illustrating the principle of the embodiments herein.

### DETAILED DESCRIPTION

The embodiments herein dynamically controls the parameter associated with the secondary side of a 3-phase transformer device, i.e. controls the inductance of the 3-phase transformer device, based on sensor data obtained from the system's sensors. The parameter associated with the secondary side of the 3-phase transformer device may be the inductance. This is in contrast to the known technology of using a fixed inductance. In addition, an operator of the system is continuously provided with information regarding grid quality, and also information about transient and stationary disturbances in the system. It is also possible to analyze the sensor data from the system, which provides a complete network analysis which may be presented on an output unit, e.g. a display, which may be local to and/or integrated within the system. It may also be possible to provide the sensor data to an external unit, e.g. via the communication unit, such as to a control room, a mobile phone etc. The external unit may be adapted to display the sensor data, in processed or non-processed form, to be viewed by an operator.

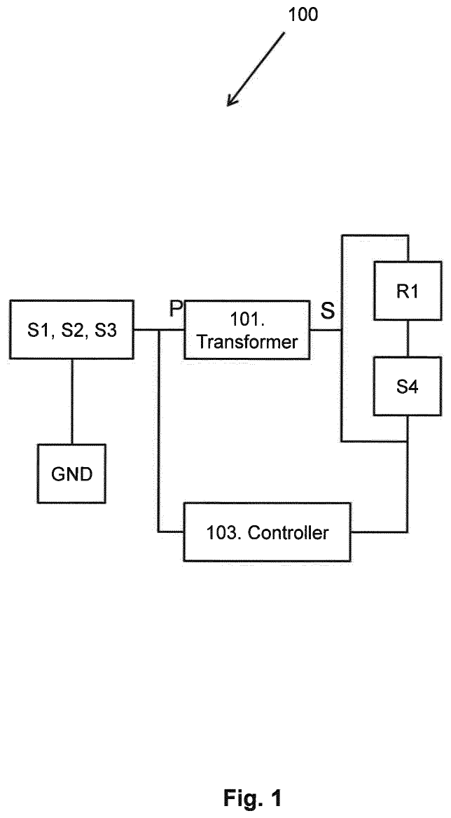

FIG. 1 is a schematic block diagram illustrating a system 100 in which embodiments herein may be implemented. The system 100 comprises a 3-phase transformer device 101 which has a primary side p and a secondary side s. The 3-phase transformer device 101 may be referred to as a transformer herein for the sake of simplicity. The primary side p and the secondary side s are separated, but they are linked together magnetically and electrically. The primary side p is exemplified to be on the left hand side of the 3-phase transformer device 101 and the secondary sides is exemplified to be on the right hand side of the 3-phase transformer device. The primary side is static and the secondary side s is adjustable, i.e. the inductance on the secondary side s is adjustable. The 3-phase transformer device 101 may also be referred to as a 3-phase variable transformer device, a 3-phase adjustable transformer device, etc. The term “variable” refers to that the secondary side s of the 3-phase transformer device 101 is variable, i.e. it may be adjusted, changed, controlled etc. The 3-phase transformer device 101 may comprise one 3-phase transformer or it may comprise three 1-phase transformers. A 1-phase transformer may also be referred to as a single phase transformer. The primary side may also be referred to as the primary winding or primary coil and the secondary side may also be referred to as the secondary winding or secondary coil of the 3-phase transformer device 101. A transformer is adapted to transfer electrical energy by means of a changing magnetic field. The primary side p may also be referred to as an input side, and the secondary side s may also be referred to as an output side of the 3-phase transformer device.

The 3-phase transformer device 101 may comprise at least one tap or at least two taps (not shown in FIG. 1) on the secondary side s. A tap may be described as a direct connection to a turn on a transformer winding at a voltage other than the normal rated voltage. The 3-phase transformer device 101 may comprise the at least one tap on the secondary side s instead of a fully adjustable model. The taps may be positioned at the secondary side s such that it is possible to select between several ratios. A ratio may be described as the relationship between the primary side p and the secondary side s. With taps, the control is performed in the same way using a controller 103 which obtains sensor data and controls the switching between the different taps on the secondary side s. The controller 103 will be described in more detail below. The term “at least one tap” may refer to one, two or more taps.

The 3-phase transformer device 101 is associated with three phases: a first phase, a second phase and a third phase. These phases may also be referred to as phase A, phase B and phase C, respectively.

The 3-phase transformer device 101 may also be referred to as a 3-phase variable transformer device with split core, a primary and secondary winding in addition to an adjustable secondary side. The ratio between the primary side p and the secondary side s may be controlled by means of a motor (not shown), and the motor may be controlled by the controller 103. The specification of the 3-phase transformer device 101 may be any suitable specification dependent on the voltage class, voltage and power. The 3-phase transformer device 101 may have one or multiple windings on the primary side and one or multiple windings on the secondary side. This way, the ratio between the primary side and the secondary side may be adjusted. Switching between the multiple windings may be controlled by a relay (not shown in FIG. 1), and the relay may be controlled by the controller 103.

Since the system 100 comprises a 3-phase transformer device 101, the system 100 may also be referred to as a 3-phase system 100.

The system 100 comprises at least one voltage sensor S1, S2, S3 adapted to sense voltage, e.g. phase voltage, at the primary side of the 3-phase transformer device 101 with reference to ground GND. Thus, the at least one voltage sensor S1, S2, S3 is adapted to be connected to the primary side p of the 3-phase transformer device 101, and the at least one voltage sensor S1, S2, S3 is adapted to be connected to ground GND. The at least one voltage sensor S1, S2, S3 senses the voltage with reference to ground. The at least one voltage sensor S1, S2, S3 may have analog outputs which may be connected to the controller 103. There may be one voltage sensor S1, S2, S3 which senses all three phases of the 3-phase transformer device 101, i.e. there may be one voltage sensor S1, S2, S3 common for all three phases. Or, there may be one voltage sensor S1, S2, S3 for each of the 3-phases, a first voltage sensor S1 for a first phase, a second voltage sensor S2 for a second phase and a third voltage sensor S3 for a third phase. The first phase may be referred to as phase A, the second phase may be referred to as phase B and the third phase may be referred to as phase C. The at least one voltage sensor S1, S2, S3 may also be referred to at least one phase voltage sensor S1, S2, S3. The term “at least one” refers to one, two or more voltage sensors.

A sensor may also be referred to as a sensing device, a measuring device, a detector etc., and may described according to the Merriam-Webster dictionary https://www.merriam-webster.com/dictionary/sensor as a “device that response to physical stimulus (such as heat, light, sound, pressure, magnetism, or a particular motion) and transmits a resulting impulse (as for measurement or operating a control)”.

The system 100 comprises a current sensor S4 adapted to sense current through the secondary sides of the 3-phase transformer device 101. Thus, current sensor S4 is adapted to be connected to the secondary side s of the 3-phase transformer device 101. The current sensor S4 may have an analogue output which may be connected to the controller 103.

The system 100 comprises a resistor R1 adapted to be connected in series with the current sensor S4 at the adjustable secondary side of the 3-phase transformer device 101. The resistor R1 may also be referred to as a power resistor. The resistor R1 may limit the current at the secondary side s of the 3-phase transformer device 101 and burns energy. The resistor R1 may correct phase shift on the current and voltage, prevent magnetic ferro resonance between system stray capacitance on the primary side p and transformer magnetic reactance, and may in such case be a pure resistive load. The resistor value may vary dependent on the voltage class of the system 100 and may be dimensioned considering a worst case.

The system 100 comprises a controller 103 adapted to obtain sensor data from at least one of the system's sensors, e.g. sensor data indicating the sensed voltage from the at least one voltage sensor S1, S2, S3, sensor data indicating the sensed current from the current sensor S4 etc. The sensor data may be at least partly continuously obtained. With at least partly continuously obtained, it is meant that the sensor data may be at least partly continuously sensed by the particular system sensor, or it may be continuously sensed by the system sensor's at all times. The system sensors may sense the sensor data at all times, at certain time intervals, which may be scheduled or random. The sensor data obtained by the controller 103 may therefore be substantially up to date at any time. When the sensors data may be at least partly continuously obtained, any change in the sensor data may be taken into account by the controller 103 within a short amount of time after the change has occurred.

The controller 103 is adapted to control a parameter of the 3-phase transformer device 101, e.g. the inductance or any other suitable parameter, and optimizes the effect of the system 100 based on obtained sensor data. This way, the ratio between the primary side and the secondary side may be adjusted.

The controller 103 is adapted to control a parameter associated with the adjustable secondary side of the 3-phase transformer device 101, T1, T2, T3 based on the obtained sensor data. It may be the inductance of the adjustable secondary side that is controlled. With the control of the inductance, the ratio between the primary side and the secondary side may be adjusted. The controlling performed by the controller 103 may be described as dynamically controlling since it is based on at least partly continuously obtained sensor data, i.e. any change in the sensor data may be reflected within a short amount of time by an appropriate control done by the controller 103.

The controller 103 may also be referred to as a network analyzer, a computer, an analyzing device, a controlling device, an adjustment device etc. The term “controlling” may be used interchangeably with the terms adjusting, changing, amending, regulating etc. The controller 103 may be for example a Digital Signal Processor (DSP), Application Specific Integrated Circuit (ASIC) processor, Field-programmable gate array (FPGA) processor or microprocessor etc. The controller 103 may be adapted to comprise a memory or to be connected to a memory (not shown in FIG. 1). The memory may comprise one or more memory units. The memory is arranged to be used to store sensor data, system data, other data, measurements, threshold values, time periods, configurations, schedulings, power measurements, voltage measurements, current measurements, and applications to perform the methods herein when being executed in the system 100.

The controller 103 may comprise or may be connected to at least one of the following components:
At least one analogue input for obtaining sensor data
At least one analogue output for adjusting a motor on the adjustable secondary side s of the 3-phase transformer device 101.
Voltage supply
Regulator adapted to adjust the inductance of the 3-phase transformer device 101 based on sensor data
Communication unit 108 for providing information to e.g. control room.
GSM unit for wireless communication.
Output unit 105.

The system 100 is adapted to be connected to a power grid (not shown) which provides electrical power to the system 100.

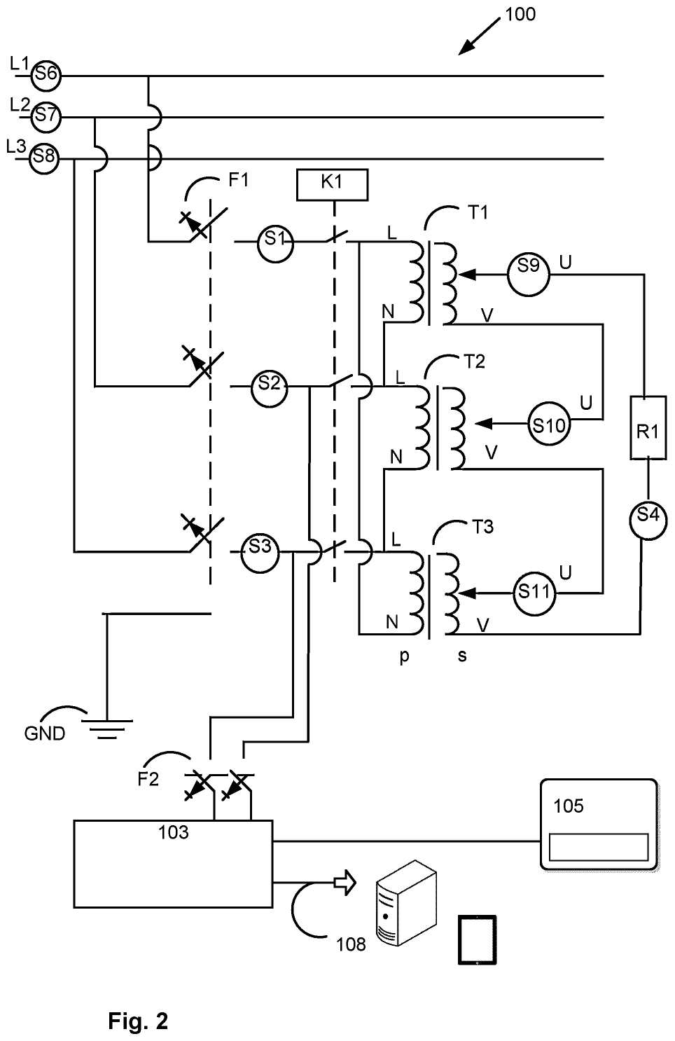

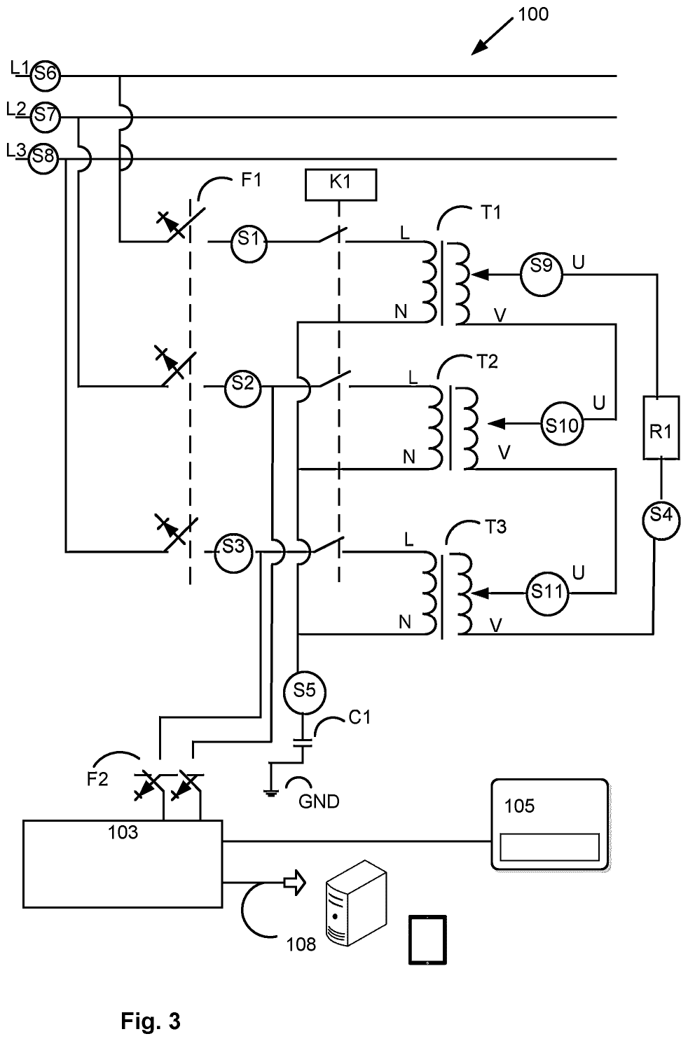

More details regarding the system 100 will now be described with reference to FIG. 2 and FIG. 3. FIG. 2 shows the system 100 being referred to as an automatic waveform restorer, and FIG. 3 shows the system 100 being referred to as an automatic voltage equalizer. Both figures shows the example where the 3-phase transformer device 101 comprises three 1-phase transformers, i.e. a first transformer T1, a second transformer T2 and a third transformer T3. However the figures are equally applicable to when the 3-phase transformer device 101 comprises one 3-phase transformer.

Starting with FIG. 2, i.e. the automatic waveform restorer. The system 100 illustrated in FIG. 2 comprises a 3-phase transformer device 101 having a primary side p and an adjustable secondary side s. The system 100 exemplified in FIG. 2 and referred to as an automatic waveform restorer may be described as a device designed to reduce and/or cancel harmonic distortion on a fundamental waveform. Harmonic noise on the system 100 means that there are one or more additional frequencies superimposed on the fundamental frequency. The fundamental frequency on the on power grid may be e.g. 50 Hz. These additional frequencies cause overheating and reduced lifespan and efficiency on electrical equipment. The term automatic waveform restorer indicates the function of restoring the distorted wave form back to its original fundamental frequency state.

L1, L2, L3 shown in FIG. 2 represents the phase supply or electrical power received by the system 100. L1 indicates a first phase, L2 indicates a second phase and L3 indicates a third phase. Thus, the system 100 is adapted to receive electrical power from the power grid, e.g. in the range of 0V-220 kV.

At least one voltage sensor S1, S2, S3 adapted to sense voltage, e.g. phase voltage, at the primary side p of the 3-phase transformer device 101 with reference to ground GND. As mentioned earlier, there may be one voltage sensor S1, S2, S3, which is adapted to sense the voltage in all three phases, or there may be three separate voltage sensors, one for each phase, i.e. one for each pair of coils. FIG. 2 shows an example with one voltage sensor S1, S2, S3 for each phase, i.e. a first voltage sensor S1, a second voltage sensor S2 and a third voltage sensor S3. The at least one voltage sensor S1, S2, S3 may also be referred to as primary side sensor or a phase voltage sensor.

The system 100 comprises a current sensor S4 adapted to sense current through the adjustable secondary side of the 3-phase transformer device 101, T1, T2, T3.

A resistor R1 is adapted to be connected in series with the current sensor S4 at the adjustable secondary side of the 3-phase transformer device 101, T1, T2, T3.

The system 100 may comprise least one input sensor S6, S7, S8 which may be adapted to sense input parameters which is input to the system 100. There may be one, two or three input sensors S6, S7, S8. For example, there may be a first input sensor S6, a second input sensor S7 and a third input sensor S8. In another example, there may be one common input sensor S6, S7, S8 for the whole system 100. The at least one input sensor S6, S7, S8 is connected to the power grid (not shown) on one side and to the primary side p of the 3-phase transformer device on the other side. The at least one input sensor S6, S7, S8 may be referred to as a sensor for network analysis and diagnostics. The input parameters sensed by the at least one input sensor S6, S7, S8 may be at least one of the following: Irms, Vrms, Watt, Var, Va, Vpk, Ipk, Frequency, Coq), Energy bidirectional, THD etc. The at least one input sensor S6, S7, S8 may be connected to the controller 103 e.g. via a Modbus protocol or similar. The at least one input sensor S6, S7, S8 may also be referred to as a power quality sensor.

A first fuse F1 may be connected to the at least one voltage sensor S1, S2, S3 and adapted to connect and disconnect the at least one voltage sensor S1, S2, S3. In case there are two or three voltage sensors, then the first fuse F1 may be adapted to activate and deactivate each of the voltage sensors, or the first fuse F1 may comprise three sub-fuses, one for each voltage sensors. The first fuse F1 may also be referred to as a main fuse. When the first fuse F1 is connected, then power from the power grid flows through the least one voltage sensor S1, S2, S3. When the first fuse F1 is disconnected, then power from the power grid does not flow through the at least one voltage sensor S1, S2, S3. The first fuse F1 may be dimensioned based on voltage and power. The vertical dotted line below the first fuse F1 in FIG. 1 indicates that, when there is one fuse common for all three phases, the fuse operation is interconnected, i.e. when the first fuse F1 connects the first voltage sensor S1, then it also connects the second voltage sensors S2 and the third voltage sensor S3. Similarly, when the first fuse F1 disconnects the first voltage sensor S1, then it also disconnects the second voltage sensor S2 and the third voltage sensor S3. When the first fuse F1 comprises three sub-fuses, one sub fuse for each phase or each voltage sensor S1, S2, S3, then each sub-fuse may operate separately, i.e. connection of the first sub-fuse may necessarily not involve connection of the other two sub-fuses, and similar for the disconnection.

A second fuse or circuit breaker (CB) F2 may be connected to the controller 103 and may be adapted to connect and/or disconnect the controller 103 from the system 100. When the controller 103 is connected, then it obtains sensor data from the system's sensors. When the controller 103 is disconnected, then it does not obtain sensor data from the system's sensors. Both a fuse and a circuit breaker serve the same purpose, which is to protect the electrical circuit. Fuses may have to be replaced after an overcurrent, whilst a circuit breaker may be reset and used multiple times. There may be one common second fuse or CB F2, or the second fuse or CB F2 may comprise two sub-fuses or CBs.

The system 100 may comprise at least one position sensors S9, S10, S11 adapted to sense position at the secondary side of the 3-phase transformer device 101, T1, T2, T3. The at least one position sensor S9, S10, S11 may also be referred to as sensor, a secondary side sensor, etc. There may be one, two or three position sensor S9, S10, S11. For example, there may be a first position sensor S9, a second position sensor S10 and a third position sensor S11. The at least one position sensor S9, S10, S11 senses the position of the slide of the 3-phase transformer device 101, and the ratio may be derived from the position. The at least one position sensor S9, S10, S11 are adapted to be variable and has a position feedback to the controller 103 such that it always comprise information about the ratio between the primary side p and the secondary side s. The at least one position sensor S9, S10, S11 may be at least one potentiometer or at least one encoder.

The system 100 may comprise a contactor K1 connected between the at least one voltage sensor S1, S2, S3 and the primary side of the 3-phase transformer device 101, T1, T2, T3. The controller 103 may be adapted to activate and/or deactivate the 3-phase transformer device 101, T1, T2, T3 with the contactor K1. The contactor K1 may be controlled by the controller 103. The dotted vertical line from the contactor K1 indicates that it may operate one each of the three phases. The contactor K may operate three switches which the dotted line goes through by means of an input signal to a coil. The coil inside may activate and trigger the three switches to be turned on. The switches will always operate together, and this is indicated with the dotted line in FIG. 1.

The system 100 comprises a controller 103 adapted to obtain sensor data from at least one of the system's sensors. For example, the controller 103 is adapted to obtain at least one of the following sensor data:
sensor data indicating the sensed voltage from the at least one voltage sensor S1, S2, S3
sensor data indicating the sensed current from the current sensor S4
sensor data indicating the sensed input parameters from the at least one input sensor S6, S7, S8.
sensor data indicating the sensed position from the at least one position sensor S9, S10, S11.

The controller 103 is adapted to control a parameter associated with the adjustable secondary side of the 3-phase transformer device 101, T1, T2, T3 based on the obtained sensor data, where the parameter may be the inductance. With the control of the inductance, the ratio between the primary side and the secondary side may be adjusted. The controller 103 obtains sensor data from the sensors, and controls motors (not shown) at the secondary sides of the 3-phase transformer device 101. The motors are not shown in the FIG. 2, but they are integrated within the 3-phase transformer device 101, T1, T2, T3. The controller 103 may control the inductance of the 3-phase transformer device 101, T1, T2, T3 and optimizes the effect of the system 100 based on obtained sensor data.

The controller 103 may be adapted to processes or analyze at least some of the sensor data, and may provide the sensor data (processed or not-processed) to be displayed on a display, to be further transmitted using a SCADA network, to a mobile phone, a table computer, to a web server etc. If the controller 103 does not process the sensor data, then the controller 103 may provide the sensor data to an external unit (not shown in FIG. 2) which performs the processing or at least part of the processing. The controller 103 may process a part of the sensor data, or it may perform a first part of the processing of all data, and then the controller 103 may provide the partly processed data to the external unit for further processing. The external unit may be co-located with the controller 103, or it may be located at a different location at some distance from the system 100. The controller 103 and/or the external unit may use the sensor data (processed or not processed) in order to determine phase angles for the voltage.

The controller 103 may be adapted to comprise a memory or to be connected to a memory (not shown in FIG. 2). The memory may comprise one or more memory units. The memory is arranged to be used to store sensor data, system data, other data, measurements, threshold values, time periods, configurations, schedulings, power measurements, voltage measurements, current measurements, and applications to perform the methods herein when being executed in the system 100.

The system 100 comprises an output unit 105 which is adapted to output sensor data. The output unit 105 may be a display, a screen, an audio device etc. The output unit 105 may be adapted to output sensor data in order for an operator to view it. The output unit 105 may be co-located with the system 100, or it may be adapted to be connected to the system 100, e.g. via a communication unit 108. The communication unit 108 may be any suitable communication link. The communication unit 108 may also provide communication between the controller 103 and an external unit, e.g. a mobile phone, an external computer, a control room etc.

FIG. 3 will now be described where the system 100 may be referred to as an automatic voltage equalizer. The system 100 illustrated in FIG. 3, referred to as an automatic voltage equalizer enables balance the voltage between the phases. If one of the power supply phases has low voltage, energy from higher voltage phases may be transferred to the lower voltage phase, and in this way try to equalize the phase voltage between the phases.

The difference between the system 100 illustrated in FIG. 2 and the system 100 illustrated in FIG. 3 is that the system 100 illustrated in FIG. 3 comprises a reference current sensor S5 and a capacitor C1 (these components are not comprised in the system 100 illustrated in FIG. 2). Another difference between the system 100 illustrated in FIG. 2 and FIG. 3 is how the 3-phase transformer device is connected, i.e. one is connected in parallel and the other in a triangle shape.

L1, L2, L3 shown in FIG. 3 represents the phase supply or electrical power received by the system 100. L1 indicates a first phase, L2 indicates a second phase and L3 indicates a third phase. Thus, the system 100 is adapted to receive electrical power from the power grid, e.g. in the range of 0V-220 kV.

The system 100 illustrated in FIG. 3 comprises a 3-phase transformer device 101 having a primary side p and an adjustable secondary side s.

At least one voltage sensor S1, S2, S3 adapted to sense voltage at the primary side p of the 3-phase transformer device 101 with reference to ground GND. The voltage sensed by the at least one voltage sensor S1, S2, S3 may be phase voltage. There may be one common voltage sensor which is adapted to sense the voltage in all three phases, or there may be three voltage sensors, one for each phase, i.e. one for each pair of coils. FIG. 3 shows an example with one voltage sensor S1, S2, S3 for each phase, i.e. a first voltage sensor S1, a second voltage sensor S2 and a third voltage sensor S3. The at least one voltage sensor S1, S2, S3 may also be referred to as primary side sensor.

The system 100 comprises a current sensor S4 adapted to sense current through the adjustable secondary side of the 3-phase transformer device 101, T1, T2, T3.

A resistor R1 is adapted to be connected in series with the current sensor S4 at the adjustable secondary side of the 3-phase transformer device 101, T1, T2, T3. The amount of kW the resistor R1 is designed for may be dependent on the voltage class and transformer size.

The system 100 may comprise least one input sensor S6, S7, S8 which may be adapted to sense input parameters which is input to the system 100. There may be one, two or three input sensors S6, S7, S8. For example, there may be a first input sensor S6, a second input sensor S7 and a third input sensor S8. In another example, there may be one common input sensor S6, S7, S8 for all three phases. The at least one input sensor S6, S7, S8 is connected to the power grid (not shown) on one side and to the primary side p of the 3-phase transformer device on the other side. The at least one input sensor S6, S7, S8 may also be referred to as a power quality sensor.

A first fuse F1 may be connected to the at least one voltage sensor S1, S2, S3 and adapted to connect and disconnect the at least one voltage sensor S1, S2, S3. In case there are two or three voltage sensors, then the first fuse F1 may be adapted to activate and deactivate each of the voltage sensors, or the first fuse F1 may comprise three sub-fuses, one for each voltage sensors. The first fuse F1 may also be referred to as a main fuse. When the fuse F1 is connected, then power from the power grid flows through the least one voltage sensor S1, S2, S3. When the first fuse F1 is disconnected, then power from the power grid does not flow through the at least one voltage sensor S1, S2, S3. The vertical dotted line below the first fuse F1 in FIG. 2 indicates that, when there is one fuse common for all three phases, the fuse operation is interconnected, i.e. when the first fuse F1 connects the first voltage sensor S1, then it also connects the second voltage sensors S2 and the third voltage sensor S3. Similarly, when the first fuse F1 disconnects the first voltage sensor S1, then it also disconnects the second voltage sensor S2 and the third voltage sensor S3. When the first fuse F1 comprises three sub-fuses, one sub fuse for each phase or each voltage sensor S1, S2, S3, then each sub-fuse may operate separately, i.e. connection of the first sub-fuse may necessarily not involve connection of the other two sub-fuses, and similar for the disconnection.

A second fuse or CB F2 may be connected to the controller 103 and may be adapted to connect and/or disconnect the controller 103 from the system 100. When the controller 103 is connected, then it obtains sensor data from the system's sensors. When the controller 130 is disconnected, then it does not obtain sensor data from the system's sensors. Both a fuse and a circuit breaker serve the same purpose, which is to protect the electrical circuit. Fuses may have to be replaced after an overcurrent, whilst a circuit breaker may be reset and used multiple times. There may be one common second fuse or CB F2, or the second fuse or CB F2 may comprise two sub-fuses or CBs.

The system 100 may comprise at least one position sensor S9, S10, S11 adapted to sense position at the secondary side of the 3-phase transformer device 101, T1, T2, T3. The at least one position sensor S9, S10, S11 may also be referred to as sensor, a secondary side sensor, etc. There may be one, two or three position sensors S9, S10, S11. For example, there may be a first position sensor S9, a second position sensor S10 and a third position sensor S11. The at least one position sensor S9, S10, S11 senses the position of the slide of the 3-phase transformer device 101, and the ratio may be derived from the position. The at least one position sensor S9, S10, S11 is adapted to be variable and has a position feedback to the controller 103 such that it comprises information about the ratio between the primary side p and the secondary side s. The at least one position sensor S9, S10, S11 may be at least one potentiometer or at least one encoder.

The system 100 may comprise a contactor K1 connected between the at least one voltage sensor S1, S2, S3 and the primary side of the 3-phase transformer device 101, T1, T2, T3. The controller 103 may be adapted to activate and/or deactivate the 3-phase transformer device 101, T1, T2, T3 with the contactor K1. The dotted vertical line from the contactor K1 indicates that it may operate one each of the three phases. The contactor K may operate three switches which the dotted line goes through by means of an input signal to a coil. The coil inside may activate and trigger the three switches to be turned on. The switches will always operate together, and this is indicated with the dotted line in FIG. 2.

The system 100 exemplified in FIG. 3 may comprise a reference current sensor S5 adapted to sense a reference current at the primary side of the 3-phase transformer device T1, T1, T2, T3 with reference to ground GND. Note that the reference current sensor S5 is not comprised in the example of the system 100 illustrated in FIG. 2. The reference current sensor S5 may have an analogue output which may be connected to the controller 130.

The system 100 exemplified in FIG. 3 may comprise a capacitor C1 connected between the reference current sensor S5 and ground GND. Note that the capacitor S1 is not comprised in the example of the system 100 illustrated in FIG. 2. The capacitor may be adapted to avoid bias currents that may damage the system 100, and to avoid faulty release of ground fault surveillance systems.

The system 100 comprises a controller 103 adapted to obtain sensor data from at least one of the system's sensors. For example, the controller 103 is adapted to obtain at least one of the following sensor data:
sensor data indicating the sensed voltage, e.g. phase voltage, from the at least one voltage sensor S1, S2, S3
sensor data indicating the sensed current from the current sensor S4 sensor data indicating the sensed reference current from the reference current sensor S5
sensor data indicating the sensed input parameters from the at least one input sensor S6, S7, S8.
sensor data indicating the sensed position from the at least one position sensor S9, S10, S11.

The controller 103 is adapted to control a parameter associated with the adjustable secondary side of the 3-phase transformer device 101, T1, T2, T3 based on the obtained sensor data. The controller 103 may control the inductance of the 3-phase transformer device 101, T1, T2, T3 and optimizes the effect of the system 100 based on obtained sensor data. The controller 103 obtains sensor data from the sensors, and controls motors at the secondary sides of the 3-phase transformer device 101. The motors are not shown in FIG. 3, but they are integrated within the 3-phase transformer device 101, T1, T2, T3, The controller 103 may be adapted to processes or analyze at least some of the sensor data, and may provide the sensor data (processed or not-processed) to be displayed on a display, to be further transmitted using a SCADA network, to a mobile phone, a table computer, to a web server etc. If the controller 103 does not process the sensor data, then the controller 103 may provide the sensor data to an external unit which performs the processing. The controller 103 may process a part of the sensor data, or it may perform a first part of the processing of all data, and then the controller 103 may provide the partly processed data to the external unit for further processing. The external unit may be co-located with the controller 103, or it may be located at a different location at some distance from the system 100. The controller 103 and/or the external unit may use the sensor data (processed or not processed) in order to determine phase angles for the voltage

The controller 103 may be adapted to comprise a memory or to be connected to a memory (not shown in FIG. 3). The memory may comprise one or more memory units. The memory is arranged to be used to store sensor data, system data, other data, measurements, threshold values, time periods, configurations, schedulings, power measurements, voltage measurements, current measurements, and applications to perform the methods herein when being executed in the system 100.

The system 100 illustrated in FIG. 3 comprises an output unit 105 which is adapted to output sensor data. The output unit 105 may be a display, a screen, an audio device etc. The output unit 105 may be adapted to output sensor data in order for an operator to view it. The output unit 105 may be co-located with the system 100, or it may be adapted to be connected to the system 100, e.g. via a communication unit 108. The communication unit 108 may be any suitable communication link. The communication unit 108 may also provide communication between the controller 103 and an external unit, e.g. a mobile phone, an external computer, a control room etc.

The control of a parameter associated with the 3-phase transformer device 101 is performed trying to achieve the best possible balance between phase-ground voltage in the primary side of the 3-phase transformer device 101, the maximum allowed and appearing power draw in the 3-phase transformer device 101, in addition to the maximum allowed power draw in the power resistor in the secondary side s of the 3-phase transformer device 101. Control of a parameter associated with the 3-phase transformer device 101 can be performed synchronously and individually when trying to achieve the most balanced phase voltage in the primary side p of the 3-phase transformer device 100.

As mentioned above, the parameter may be the inductance or any other suitable parameter. With the control of the inductance, the ratio between the primary side and the secondary side may be adjusted.

One purpose of the control of the parameter, e.g. inductance, associated with the 3-phase transformer device 101 may be to control the power and current of the secondary side s of the 3-phase transformer device 101 in order to achieve an optimal flow of energy such that the best possible balanced phase voltage is achieved even at small voltage variations at the power grid. This may be done by transferring energy from the phase/phases with a higher voltage level back into the phase/phases with the lower voltage level. The size of the 3-phase transformer device 101 may be varying, and it may be dimensioned based on the voltage level at secondary side of the power grid's transformer, in addition to the type of power grid the system 100 is connected to (grounded or not grounded power grid), having maximum ground current in mind. Maximum ground current at full ground fault at a phase is dependent on the type of power grid which the system 100 is connected to, and to the inductance to ground. The power resistor in the secondary side of the 3-phase transformer device 101 may be dimensioned based on the maximum allowed power through a variable transformer and will protect the transformer windings against over load and due to magnetic ferro resonance between system stray capacitance on primary side p of the 3-phase transformer device 101, T1, T2, T3 and the magnetic reactance of the 3-phase transformer device 101, T1, T2, T3.

At full ground fault at a phase, it is desirable to have the maximum allowed power draw through the variable transformer connected to phases without ground fault (worst case scenario). Apparent power will correspond to the current draw multiplied with voltage loss over a variable transformer:

Strafo=Utrafo·Itrafo

Strafo=Apparent power variable transformer VA

Utrafo=Voltage loss over variable transformer [V]

Itrafo=Current draw variable transformer [A]

Power loss over the resistor R1 in the secondary side s will be dependent on the voltage loss over the resistor R1, and may be calculated using Kirchhoff's voltage law:

Utrafo1+Utrafo2+Utrafo3=Uresistor

Based on voltage loss over the resistor R1, the current in the secondary side may be calculated as follows

Iresistor=UresistorRresistor

Based on the current in the secondary side s, the power loss over the resistor R1 can be calculated as follows:

PMresistor=Uresistor·Iresistor

By means of the above calculation, the 3-phase transformer device 101 can be controlled aiming for the optimal current level at the secondary side s in order to achieve the best possible phase voltage without exceeding the maximum allowed power through the power resistor R1 or the 3-phase transformer device 101. The system 100 will take energy from higher phases and transfer it via the secondary side of the 3-phase transformer device 101 back to a lower phase.

As a safety measure against high power in the secondary side of the 3-phase transformer device, the system 100 may comprise a software stop mechanism and a shutdown mechanism, in addition to mechanical end stops at the 3-phase transformer device 101.

The controller 103 continuously obtains sensor data from the system's sensors, and these sensor data is used in order to determine how to control a parameter, e.g. inductance, associated with the secondary side s of the 3-phase transformer device 101. Below is a table providing an overview of sensors and short information about parameters that they sense. The system 100 may comprise at least one of these sensors:

| Reference | | |
|---|---|---|
| number in | | SI |
| FIGS. | Type of sensor | unit |
| S1, S2, S3 | Voltage sensor - senses voltage at the primary side of | V |
| | the 3-phase transformer device | |
| S4 | Current sensor - senses current at the secondary side of | A |
| | the 3-phase transformer device | |
| S5 | Current sensor - senses reference current at the primary | |
| | side of the 3-phase transformer device with reference | |
| | to ground | |
| S6, S7, S8 | Input sensor - senses input parameters input to the | |
| | system 100 | |
| S9, S10, | Position sensor | |
| S11 | | |

The system 100 uses a 3-phase transformer device with an adjustable and variable secondary side which is controlled by motors (not shown). The motors are integrated in the single-phase transformer. The motors adjust the inductance in the secondary side based on sensor data from the system's controller 103. The controller 103 controls the system 100 based on the sensor data obtained from the system's sensors such that it optimizes the system at certain time intervals, continuously or when triggered. In addition, the sensor data may be provided to the output unit 105 and/or the external unit such that an operator can analyze the sensor data and take necessary actions. The sensor data can be provided to the output unit 105 and/or the external unit e.g. via a wired or wireless communication link. The controller 103 may perform processing of the sensor data, the controller 103 may provide the sensor data to the output unit 105 and/or the external unit for processing. The controller 103 may perform a part of the sensor data processing and the output unit 105 and/or the external unit may perform another part of the sensor data processing. The controller may communicate with the output unit 105 and/or the external unit via a communication link.

There are products for voltage stabilization that are based on electromagnetism, but no existing product combines this with a digital processor which regulates the inductance and optimizes the effect based on collected data.

With the present invention, data is collected from the system sensors. The present invention enables adjustments and optimization of inductance (magnetism) based on the collected sensor data. In the present invention, the collected sensor data is utilized to provide a substantially full network status which can be presented locally on a display, or communicated to e.g. a control room through a communication port or a wireless GSM sender.

The system 100 is applicable to various voltage and power classes. The system 100 may be applied in systems within the range of 0V-220 kV.

The system 100 may be a standalone system or it may be incorporated in to electric devices such as e.g. frequency converters, chargers for electric cars etc.

The system 100 may also be referred to as an Electromagnetic High Resistance Grounding System.

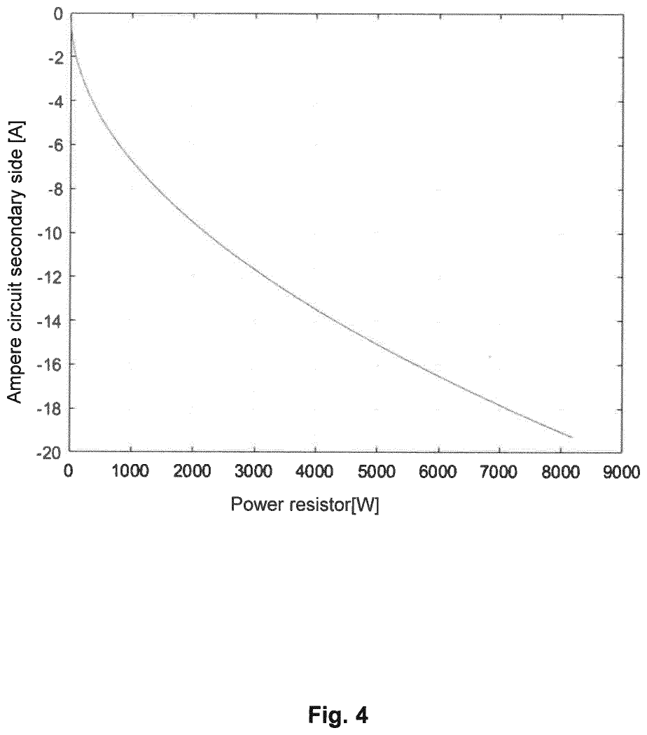

An example will now be provided with reference to FIGS. 4, 5 and 6. At full ground fault at a phase in a 230V IT grid, there will be a voltage drop over the two transformers connected to phases without ground fault, which is equal to a phase-phase voltage of 230V. Appearing power “S” through the 3-phase transformer device 101 will then be dependent on the ground current since the appearing power is given by S=U*I [VA].

FIG. 4 is a graph illustrating power loss over the resistor R1 (22 Ohm) based on voltage and current in the secondary side s of the 3-phase transformer device 101, and based on voltage drop over the resistor R1. The example is based on a 3-phase transformer device 101 of 713VA, 3.1 A, 0-245V and in a 230V IT grid. The specification of the 3-phase transformer 101 and the resistor R1 will vary for different voltage classes and transformer KVA size. The x-axis of FIG. 4 represents the power in the resistor and is measured in Watt (W). The y-axis of FIG. 4 represents the ampere at the secondary side s of the 3-phase transformer device 101 and is measure in ampere (A).

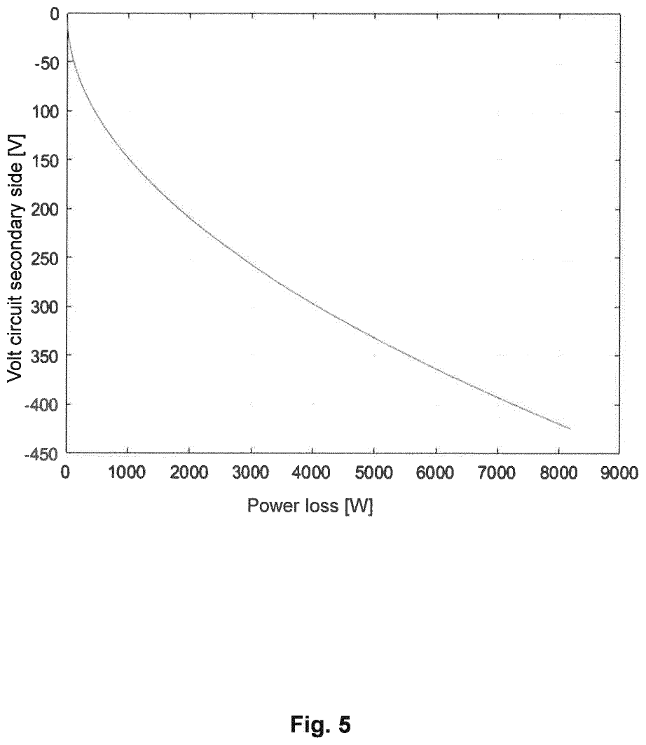

FIG. 5 is a graph illustrating power loss over the resistor R1 (22 Ohm) based on voltage loss over the resistor R1. The x-axis of FIG. 5 represents power loss and is measured in W. The y-axis of FIG. 5 represents voltage at the secondary side of the 3-phase transformer device 101 and is measured in V.

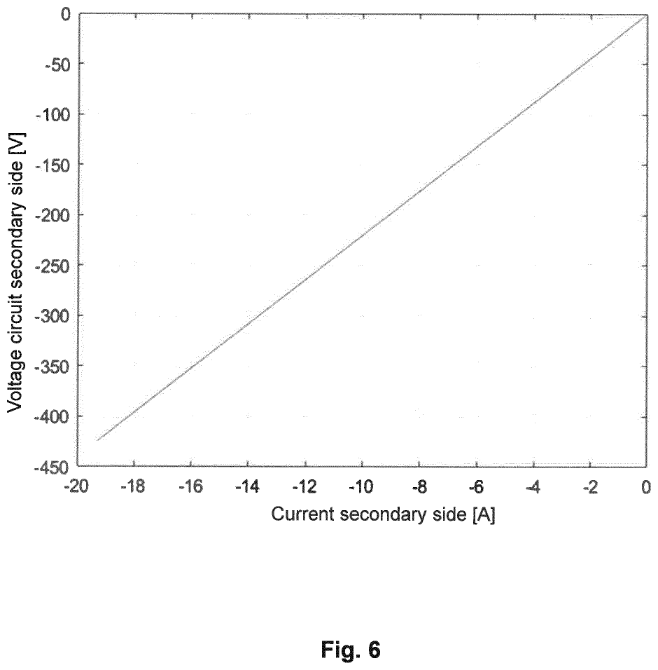

FIG. 6 is a graph illustrating current at the secondary side of the 3-phase transformer device 101 based on voltage loss over the resistor R1 (22 Ohm). The x-axis of FIG. 6 represents current at the secondary sides of the 3-phase transformer device 101. The y-axis of FIG. 6 represents the voltage at the secondary side of the 3-phase transformer device 101 and is measured in V.

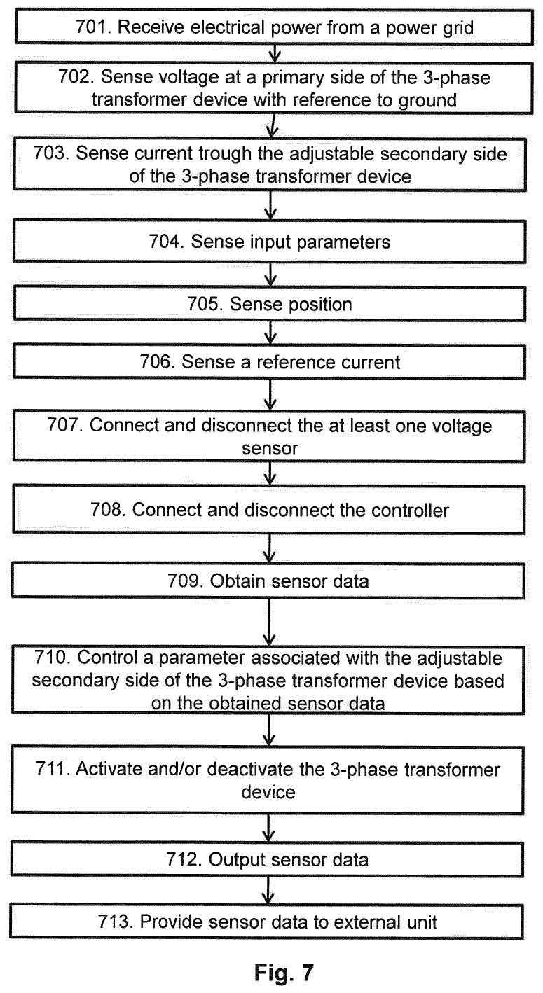

FIG. 7 is a flow chart illustrating a method. The method comprises at least one of the following steps, which steps may be performed in any suitable order than described below:

Step 701

The system 100 receives electrical power from a power grid.

Step 702

The system 100 senses voltage at a primary side of the 3-phase transformer device 101, T1, T2, T3 with reference to ground GND. The sensing is performed with at least one voltage sensor S1, S2, S3.

A first voltage sensor S1 may sense voltage at the primary side of a first 1-phase transformer T1. A second voltage sensor S2 may sense voltage at the primary side of a second 1-phase transformer T2. A third voltage sensor S3 may sense voltage at the primary side of a third 1-phase transformer T3.

Step 703

The system 100 senses current trough the adjustable secondary side of the 3-phase transformer device 101, T1, T2, T3 with a current sensor S4. A resistor R1 is connected in series with the current sensor S4 at the adjustable secondary side of the 3-phase transformer device T1, T2, T3.

Step 704

The system 100 may sense, through at least one input sensor S6, S7, S8, input parameters which is input to the system 100.

Step 705

The system 100 may sense, through at least one position sensor S9, S10, S11, position at the secondary side of the 3-phase transformer device 101, T1, T2, T3.

Step 706

The system 100 may sense, through a reference current sensor S5, a reference current at the primary side of the 3-phase transformer device 101, T1, T2, T3 with reference to ground GND.

Step 707

The system 100 may, through at least one first fuse F1 connected to the at least one voltage sensor S1, S2, S3, connect and disconnect the at least one voltage sensor S1, S2, S3.

Step 708

The system may 100, through at least one second fuse or CB F2 connected to the controller 103, connect and disconnect the controller 103 from the system 100.

Step 709

The system 100 obtains, with a controller 103, sensor data indicating the sensed voltage from the at least one voltage sensor S1, S2, S3 and the sensed current from the current sensor S4.

The obtained sensor data may further indicate the sensed input parameters from the at least one input sensor S6, S7, S8.

The obtained sensor data may further indicate the sensed position from the at least one position sensor S9, S10, S11.

The obtained sensor data may further indicates the sensed reference current from the reference current sensor S5.

Step 710

The system 100 controls, with the controller 103, a parameter associated with the adjustable secondary side of the 3-phase transformer device 101, T1, T2, T3 based on the obtained sensor data. The controller 103 may control the inductance of the 3-phase transformer device 101, T1, T2, T3 and optimizes the effect of the system 100 based on obtained sensor data. The parameter may be the inductance of the 3-phase transformer device 101. With the control of the inductance, the ratio between the primary side and the secondary side may be adjusted.

The controller 103 may control a parameter, e.g. inductance, associated with the adjustable secondary side of the 3-phase transformer device 101, T1, T2, T3 based on the obtained sensor data through a motor. The parameter may be the inductance of the 3-phase transformer device 101, T1, T2, T3.

Step 711

The system 100 may, through the controller 103, activate and/or deactivate the 3-phase transformer device 101, T1, T2, T3 with the contactor K1. The contactor K1 may be connected between the at least one voltage sensor S1, S2, S3 and the primary side of the 3-phase transformer device 101, T1, T2, T3.

Step 712

The system 100 may output the sensor data through an output unit 105.

Step 713

The system 100 may provide the sensor data to an external unit via a communication unit 108.

The system 100 may comprise a capacitor C1 connected between the reference current sensor S5 and ground GND.

The 3-phase transformer device 101, T1, T2, T3 may be a variable 3-phase transformer device.

The 3-phase transformer device 101 may comprise one 3-phase variable transformer. The 3-phase transformer device 101 may comprise three 1-phase variable transformers T1, T2, T3. The three 1-phase transformers T1, T2, T3 may be connected together in a delta configuration or a Wye (Y) configuration at their primary side. A Wye configuration is a configuration is when all the phases are connected at a single point. In a delta configuration, the 3 phases are connected like in a triangle. The Wye configuration may also be referred to as a start configuration. The delta configuration may also be referred to as a mesh configuration. The interconnection of the windings in a transformer determines whether the configuration is a Wye or delta configuration.

The system 100 may be adapted to handle an input voltage in the range of 0V-220 kV.

The embodiments herein are based on a 3-phase transformer device 101 which has an associated parameter which is controlled by the controller 103. The parameter may be the inductance. The inductance in turn regulates the ratio between the primary and secondary side. The controller 103 may regulate the inductance of the 3-phase transformer device 101 based on sensed voltage between phase and ground, current in each phase, and based on frequency of current and voltage. With this, it is possible to optimize the inductance value for the 3-phase transformer device 101 such that a phase voltage which is as stable as possible is achieved, in addition to a 120 degree phase shift for both current and voltage. It also optimizes the inductance value in order to reduce the total harmonic disturbance in the best possible way. The 3-phase transformer device 101 may be connected in a delta configuration or a Wye (Y) configuration, on the primary side p based on the desired functionality. The system 10 may be connected in parallel to a 3-phase phase grid on the primary side s of the 3-phase transformer device 101.

Voltage Stabilizing

The system 100 logs, at any time, the phase voltages with respect to ground, in addition to current draw at the primary side of the single phase transformer. Based on this, the inductance in the adjustable secondary side of the 3-phase transformer device 101 it adjusted at certain time interval. This achieves optimal voltage stabilization.

Network Analysis and Diagnostics

Phase voltages, the phase currents of the system 100, in addition to current in the adjustable secondary side s of the 3-phase transformer device may be logged at any time, and the logged data, i.e. the sensor data, may be obtained by the controller 103. Phase currents from the secondary side of the 3-phase transformer device 101 may also be obtained by the controller 103, e.g. in order to determine the power consumption of the network, power factor, current draw, in order to provide a total overview of the power grid quality and consumption. The system 100 may have an output unit 108, e.g. integrated within the system 100, with the possibility to output the sensor data.

Harmonic Noise Reduction

The system 100 logs harmonic currents and voltages at any time. Based on this, the system 100 controls the inductance of the adjustable secondary side of the 3-phase transformer device 101 at given time intervals. This provides optimal reduction of harmonic currents and voltages.

Transient Over Voltages

The system 100 may reduce transient over voltages based on its composition and may function as a lightning and over voltage protector, light arc protection and it may reduce other voltage pulses on the power grid. The power resistor in the secondary side s may burn excess energy in order to protect the windings in the 3-phase transformer device 101.

Alarm, Logging and Data Transfer

Based on the sensor data obtained by the system 100, a full network diagnostics may be provided, which may be presented at the output unit 105 or sent via the communication unit 108 to an external unit. Ground error alarm based on current draw in the secondary side s, in addition to alarms describing various transient scenarios on the power grid may be some of the information that may be derived from the sensor data and presented on the output unit 105.

Frequency Transformer

Frequency transformers comprise power electronics which is a source of harmonic noise and reduces the life time and degree of effectivity of connected motors. A custom designed unit may be positioned after the 3-phase transformer device 101, or possibly be built into the 3-phase transformer device 101 in order to cancel harmonic noise and stabilize the voltage.

The system 100 is based on electromagnetism. By means of the 3-phase transformer device 101, the system 100 distributes energy between the three phases based on physical laws such as e.g. Faradays law and Lenz law.

At unbalance at the phase voltages on the primary side p, the 3-phase transformer device 101 may set up a magnetic field. Based on the magnetic field, a current will run through the secondary side s. The system 100 may then evenly distribute the available energy between the phases. The system 100 is based on a 3-phase transformer device 101 which may adjust the inductance in the secondary side s by means of a regulator, and which is based on obtained sensor data. The inductance in turn regulates the ratio between the primary and secondary side The system 100 may be connected to a secondary side of a power grid transformer, and in parallel to the circuit.

The primary side p of the 3-phase transformer device 101 may be connected in a WYE configuration with zero point referring to ground, or in a delta shape where the ground connection is not present. The Wye configuration may be used when an objective of the system 100 is to balance the phase voltage. The delta configuration may be used when an objective of the system 100 is to remove harmonic noise etc. The delta shape may be used on a delta star/star-star configured power grid transformer with N conductor, where a load is taken out between the phase and ground where load generated harmonic noise is present.

The system 100 may also comprise wireless or wired sensor data transmission, or both.

Some embodiments described herein may be summarized in the following manner:

A system 100 comprising:
a 3-phase transformer device 101, T1, T2, T3 having a primary side and an adjustable secondary side;
at least one voltage sensor S1, S2, S3 adapted to sense voltage at the primary side of the 3-phase transformer device 101, T1, T2, T3 with reference to ground GND;
a current sensor S4 adapted to sense current through the adjustable secondary side of the 3-phase transformer device 101, T1, T2, T3,
a resistor R1 connected in series with the current sensor S4 at the adjustable secondary side of the 3-phase transformer device 101, T1, T2, T3;
a controller 103 adapted to:
   obtain sensor data indicating the sensed voltage from the at least one voltage sensor S1, S2, S3 and the sensed current from the current sensor S4, and to
   control a parameter associated with the adjustable secondary side of the 3-phase transformer device 101, T1, T2, T3 based on the obtained sensor data.

The system 100 may comprise at least one input sensor S6, S7, S8 adapted to sense input parameters which is input to the system 100. The obtained sensor data may further indicates the sensed input parameters from the at least one input sensor S6, S7, S8.

The system 100 may comprise at least one position sensor S9, S10, S11 adapted to sense the position of the slide on the secondary side of the 3-phase transformer device 101, T1, T2, T3. The obtained sensor data may further indicate the ratio between the primary and secondary side of the 3-phase transformer device 101.

The system 100 may comprise a reference current sensor S5 adapted to sense a reference current at the primary side of the 3-phase transformer device 101, T1, T2, T3 with reference to ground GND. The obtained sensor data may further indicate the sensed reference current from the reference current sensor S5.

The system 100 may comprise a capacitor C1 connected between the reference current sensor S5 and ground GND.

The controller 103 may be adapted to control a parameter associated with the adjustable secondary side of the 3-phase transformer device 101, T1, T2, T3 based on the obtained sensor data through a motor. The parameter may be the inductance.

The 3-phase transformer device 101, T1, T2, T3 may be a variable 3 phase transformer device.

At least one first fuse F1 may be connected to the at least one voltage sensor S1, S2, S3 and adapted to connect and disconnect the at least one voltage sensor S1, S2, S3.

At least one second fuse F2 or CB may be connected to the controller 103 and adapted to connect and disconnect the controller 103 from the system 100.

The system 100 may comprise a contactor K1 connected between the at least one voltage sensor S1, S2, S3 and the primary side of the 3-phase transformer device 101, T1, T2, T3. The controller 103 may be adapted to activate and/or deactivate the 3-phase transformer device 101, T1, T2, T3 with the contactor K1.

The 3-phase transformer device 101 may comprise one 3-phase variable transformer.

The 3-phase transformer device 101 may comprise three 1-phase variable transformers T1, T2, T3.

A first voltage sensor S1 may be adapted to sense voltage at the primary side of a first 1-phase transformer T1. A second voltage sensor S2 may be adapted to sense voltage at the primary side of a second 1-phase transformer T2. A third voltage sensor S3 may be adapted to sense voltage at the primary side of a third 1-phase transformer T3.

The three 1-phase transformers T1, T2, T3 may be connected together in a delta configuration or Wye configuration at their primary side.

The system 100 may comprise an output unit 105 adapted to output the sensor data.

The system 100 may comprise a communication unit 108 adapted to provide the sensor data to an external unit.

The system 100 may be adapted to handle an input voltage in the range of 0V-220 kV.

The embodiments herein are not limited to the above described embodiments. Various alternatives, modifications and equivalents may be used. Therefore, the above embodiments should not be taken as limiting the scope of the embodiments, which is defined by the appended claims. A feature from one embodiment may be combined with one or more features of any other embodiment.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

It should also be emphasised that the steps of the methods defined in the appended claims may, without departing from the embodiments herein, be performed in another order than the order in which they appear in the claims.

1. A system for controlling a 3-phase transformer device, the system comprising:
the 3-phase transformer device comprising a primary side and an adjustable secondary side;
at least one voltage sensor adapted to sense voltage at the primary side of the 3-phase transformer device with reference to ground;
a current sensor adapted to sense current through the adjustable secondary side of the 3-phase transformer device,
a resistor connected in series with the current sensor at the adjustable secondary side of the 3-phase transformer device;
a controller adapted to:
obtain sensor data indicating the sensed voltage from the at least one voltage sensor and the sensed current from the current sensor, and to
control a parameter associated with the adjustable secondary side of the 3-phase transformer device based on the obtained sensor data.

2. The system according to claim 1, comprising;
at least one input sensor adapted to sense input parameters which are input to the system,
wherein the obtained sensor data further indicates the sensed input parameters from the at least one input sensor.

3. The system according to claim 1, comprising:
at least one position sensor adapted to sense position at the secondary side of the 3-phase transformer device, and
wherein the obtained sensor data further indicates the sensed position from the at least one position sensor.

4. The system according to claim 1, comprising:
a reference current sensor adapted to sense a reference current at the primary side of the 3-phase transformer device with reference to ground, and
wherein the obtained sensor data further indicates the sensed reference current from the reference current sensor.

5. The system according to claim 4, comprising:
a capacitor connected between the reference current
sensor and ground.

6. The system according to claim 1, wherein the controller is adapted to control a parameter associated with the adjustable secondary side of the 3-phase transformer device based on the obtained sensor data through a motor.

7. (canceled)

8. The system according to claim 1, wherein at least one first fuse is connected to the at least one voltage sensor and adapted to connect and disconnect the at least one voltage sensor.

9. The system according to claim 1, wherein at least one second fuse or circuit breaker is connected to the controller and adapted to connect and disconnect the controller from the system.

10. The system according to claim 1, comprising a contactor connected between the at least one voltage sensor and the primary side of the 3-phase transformer device, and
wherein the controller is adapted to activate and/or deactivate the 3-phase transformer device with the contactor.

11. The system according to claim 1, wherein the 3-phase transformer device (101) comprises one 3-phase variable transformer.

12. The system according to claim 1, wherein the 3-phase transformer device (101) comprises three 1-phase variable transformers.

13. The system according to claim 12, wherein
a first voltage sensor is adapted to sense voltage at the primary side of a first 1-phase transformer,
a second voltage sensor is adapted to sense voltage at the primary side of a second 1-phase transformer and
a third voltage sensor is adapted to sense voltage at the primary side of a third 1-phase transformer.

14. The system according to claim 12, wherein the three 1-phase transformers are connected together in a Wye configuration or a delta configuration shape at their primary side.

15. The system according to claim 1, comprising:
an output unit adapted to output the sensor data.

16. The system according to claim 1, comprising:
a communication unit adapted to provide the sensor data to an external unit.

17. The system according to claim 1, adapted to handle an input voltage in the range of 0V-220 kV.

18. A method performed by a system for controlling a 3-phase transformer device, the method comprising:
receiving electrical power from a power grid;
sensing voltage at a primary side of the 3-phase transformer device with reference to ground and with at least one voltage sensor;
sensing current trough an adjustable secondary side of the 3-phase transformer device with a current sensor, wherein a resistor is connected in series with the current sensor at the adjustable secondary side of the 3-phase transformer device;
obtaining, with a controller, sensor data indicating the sensed voltage from the at least one voltage sensor and the sensed current from the current sensor; and
controlling, with the controller, a parameter associated with the adjustable secondary side of the 3-phase transformer device based on the obtained sensor data.

19. The system according to claim 1, wherein the 3-phase transformer device is a variable 3-phase transformer device.
